(19) United States
(12) Patent Application Publication
(10) Pub. No.: US 2008/0254171 A1
(43) Pub. Date: Oct. 16, 2008

(54) Spreadable fruit preparation having a low content of solids and methods of manufacture

(76) Inventors: Peter Mattson, Hillsborough, CA (US); Peter Dea, San Leandro, CA (US)

Correspondence Address: MORRISON & FOERSTER LLP, 425 MARKET STREET, SAN FRANCISCO, CA, 94105-2482, US

(21) Appl. No.: 11/786,895

(22) Filed: Apr. 13, 2007

(51) Int. Cl. A23L 1/06; A23B 7/08

(52) U.S. Cl. 426/131; 426/573

(57) ABSTRACT

A spreadable fruit preparation having a low content of soluble solids contains fruit, sugar, citric acid, and pectin. The percent by weight of total soluble solids of the spreadable fruit preparation is less than 50 percent, the sugar content of one mL of the spreadable fruit preparation is less than about 0.634 grams of sugar per mL of the spreadable fruit preparation, and the caloric content is less than about 2.536 kilocalories per mL of the spreadable fruit preparation.

### BACKGROUND

1. Field

The present application relates generally to spreadable fruit preparations and, more specifically, to spreadable fruit preparations having a low content of soluble solids.

2. Related Art

Spreadable fruit preparations, such as jams, jellies, marmalades, preserves, and the like, are combinations of fruit, sugar, a gelling agent, such as pectin, and acid, which have been heated and set to yield a spreadable, gelatinous condiment. It is desirable for the spreadable fruit preparation to maintain a high degree of fruit flavor, color, and consistency, as well as exhibiting an acceptable degree of shelf-life stability. Health-conscious consumers also desire a spreadable fruit preparation having a relatively low caloric content, and even more preferably, one which is free of artificial sugar substitutes. From a commercial perspective, it is desirable for a spreadable fruit preparation to have a low cost and time of manufacture.

A typical fruit preserve, such as Smuckers® Strawberry Preserve, has a soluble solids content of about 65° Brix, a sugar content of about 0.8 g/mL (about 12 grams per tablespoon), and a Caloric content of 3.2 kilocalories (about 48 kilocalories per tablespoon).

Accordingly, there is a need for a spreadable fruit preparation with characteristics which appeal to health-conscious consumers, yet also has a relatively low cost of manufacture.

### SUMMARY

Described herein are spreadable fruit preparations having a low caloric content and low cost of manufacture. In one embodiment, the fruit preparation contains fruit, sugar, citrict acid, and pectin; wherein the percent by weight of total soluble solids of the spreadable fruit preparation is less than 50 percent, the sugar content of one mL of the spreadable fruit preparation is less than about 0.634 grams of sugar per mL of the spreadable fruit preparation, and the caloric content of the spreadable fruit preparation is less than about 2.536 kilocalories per mL.

In another embodiment, the spreadable fruit preparation has a percent by weight of total soluble solids of less than 40 percent. In an alternative embodiment, the spreadable fruit preparation has a sugar content of less than about 0.4 grams of sugar per mL of the spreadable fruit preparation. Also described is a spreadable fruit preparation having a caloric content of less than about 1.6 kilocalories per mL of the spreadable fruit preparation. In one embodiment, the spreadable fruit preparation does not contain a sugar substitute.

The fruit of the spreadable fruit preparation may be selected from strawberry, raspberry, blackberry, peach, apricot, blueberry, boysenberry, cherry, pineapple, pomegranate and orange. The sugar of the spreadable fruit preparation may be selected from sucrose, glucose, and fructose.

In an embodiment, the spreadable fruit preparation may be provided in a hermetically sealed container. In another embodiment, the spreadable fruit preparation may be stable at room temperature for one year.

Also described herein is a method of manufacturing a spreadable fruit preparation, the method having the steps of: combining the fruit, sugar, citric acid, and pectin to form a mixture; and heating the mixture to yield the spreadable fruit preparation; the spreadable fruit preparation prepared according to this method has a percent by weight of total soluble solids of less than 50 percent, a sugar content of less than about 0.634 grams of sugar per mL of the spreadable fruit preparation, and a caloric content of less than about 2.536 kilocalories per mL of the spreadable fruit preparation.

In one embodiment, the spreadable fruit preparation made according to the methods described has a percent by weight of total soluble solids of less than 40 percent. In another embodiment, the spreadable fruit preparation made according to the methods described has a sugar content of less than about 0.4 grams of sugar per mL of the spreadable fruit preparation. The spreadable fruit preparation made according to the methods described has may have a caloric content of less than about 1.6 kilocalories per mL of the spreadable fruit preparation.

In an embodiment of the method, the resulting spreadable fruit preparation does not contain a sugar substitute. The spreadable fruit preparation made according to the methods described has fruit selected from strawberry, raspberry, blackberry, peach, apricot, blueberry, boysenberry, cherry, pineapple, and orange. The resulting spreadable fruit preparation may contain a sugar selected from sucrose, glucose, and fructose.

In an alternative embodiment, the method of manufacturing a spreadable fruit preparation includes the step of providing the spreadable fruit preparation in a hermetically sealed container. The spreadable fruit preparation made according to the disclosed methods may be stable at room temperature for one year.

### DETAILED DESCRIPTION

The present application is directed to a spreadable fruit preparation having a low content of soluble solids, and to methods for producing the same.

The following description sets forth numerous exemplary compositions, methods, and the like. It should be recognized, however, that such description is not intended as a limitation on the scope of the present invention, but is instead provided as a description of exemplary embodiments.

### A. SPREADABLE FRUIT PREPARATION HAVING A LOW CONTENT OF SOLIDS

The spreadable fruit preparation described herein preferably includes one or more fruits, one or more sugars, one or more food-safe acids, one and one or more gelling agents. The spreadable fruit preparation has a low percent by weight of total solids. Preferably, the total weigh of soluble solids is less than 60 percent, more preferably less than 50 percent, and even more preferably less than 40 percent.

Additional coloring or flavor may be included in the spreadable fruit preparation. For example, beet color or natural strawberry flavor may be added. Such additions may provide the spreadable fruit product with a color and flavor highly reminiscent of fresh fruit.

It is understood that any fruit may be employed. Fruits commonly used for jamming or preserving, such as berries, stone fruits, citrus fruits, and the like, may be preferred. It is similarly understood that any sugar may be employed. Common food sugars such as sucrose (i.e. table sugar), glucose syrup (i.e. corn syrup), and high fructose corn syrup, may be preferred. It is also understood that any food-safe acid, such as citric acid, may be employed. It is further understood that any gelling agent may be employed and that pectin is preferred. The quantity of added gelling agent may vary with the fruit selected, as fruits typically have a natural pectin content which varies between fruits.

The spreadable fruit preparation has a low content of soluble solids, which may be determined through standard methods. For example, the solids content may be determined through the use of a refractometer and expressed as an RDS (refractometric dried substance) value, which expresses the percent by weight of dried solids. The percentage of solids may also be expressed as a degrees Brix value. While the Brix value is a measurement of the mass ratio of dissolved sugar to liquid, it is not uncommon to express the solids content of a jam, jelly, or the like, as a degrees Brix value, given that the majority of dried solids are typically sugars.

The spreadable fruit preparation typically has a low caloric content, given the low content of soluble solids (e.g. sugars). The sugar content of the spreadable fruit preparation is typically less than 10 grams per tablespoon or 15 mL of the product (0.667 g/mL), and even more preferably, less than 6 grams per tablespoon (0.4 g/mL). Preferably, the caloric content per tablespoon or 15 mL of the spreadable fruit preparation is no more than 38 kilocalories (2.536 kcal/mL), and even more preferably no more than 24 kilocalories per tablespoon (1.6 kcal/mL). Sugar substitutes may be employed, but it may be found preferable to exclude sugar substitutes.

The spreadable fruit preparation may be packaged in a hermetically sealed container, such as a lidded, air-tight glass jar. It is preferable that the spreadable fruit preparation is stable at room temperatures for at least one year. “Room temperature,” as used herein, refers to indoor temperatures commonly encountered in modern food markets, typically on the order of about 75° F.

### B. METHOD OF MANUFACTURE

The spreadable fruit preparation may be manufactured using methods common to the production of jams, jellies, preserves, and the like.

Alternatively, the spreadable fruit preparation may be manufactured using hot-filling methods. It is understood that due to the low content of soluble solids, a large degree of evaporative concentration is not necessary. Weight loss during manufacture (e.g., evaporative weight loss) may be extremely low: 5% or less of starting weight, 3% or less of starting weight, or 1% or less of starting weight, may be lost during manufacture.

Accordingly, the spreadable fruit preparation having a low content of soluble solids may generally be manufactured with time and energy demands lower than that of a fruit preparation having a higher concentration of soluble solids.

Provided below are exemplary spreadable fruit preparations and their methods of manufacture.

### C. EXAMPLE 1: STRAWBERRY FRUIT SPREAD

A strawberry fruit spread having a soluble solid content of approximately 28-29° Brix was prepared from the components in table 1. Yield is 893.43 grams or approximately 788.3 mLs.

TABLE 1

| Component | Supplier | Weight (g) | Percent |
|---|---|---|---|
| Strawberry, Organic | North Pacific ™ | 450.850 | 50.463% |
| Water | Pacific Choice ™ | 150.000 | 16.789% |
| Cane Sugar, Organic | Florida Crystals ™ | 257.000 | 28.766% |
| Citric Acid 50% Solution | | 18.500 | 2.071% |
| Pectin | Danisco ™ | 9.000 | 1.007% |
| Strawberry Flavor | Ungerer ™ | 4.000 | 0.448% |
| Locust Bean Gum | TIC ™ | 2.680 | 0.300% |
| Color | Exberry ™ | 1.200 | 0.134% |
| Antifoam | Magrabar ™ | 0.200 | 0.022% |
| | | 893.43 | 100.000% |

Production proceeds as follows. A pre-blend is formed of the pectin and the locust bean gum mixed with 15% of the cane sugar. The pre-blend is combined with the water and mixed for approximately three minutes to form a slurry. The slurry is heated to 200° F., at which point the remaining 85% of the cane sugar is added. The temperature is reduced to 165° F. and the strawberries are added, while mixing continues. The temperature is reduced to 130° F. and the defoamer added. The temperature is then raised to 150° F. and the color, strawberry flavor, and citric acid are added. Mixing continues for five minutes after the final additions. The mixture is heated to 185° F. prior to hot-filling into jars.

### D. EXAMPLE 2: MIXED BERRY FRUIT SPREAD

A mixed berry fruit spread having a soluble solid content of approximately 28-29° Brix was prepared from the components in table 2. Yield is 879.8 grams or approximately 776.3 mLs.

| | | Weight | |
|---|---|---|---|
| Component | Supplier | (g) | Percent |
| Strawberries, Organic IQF | North Pacific ™ | 250.000 | 28.41555% |
| Raspberries, Organic IQF | North Pacific ™ | 100.000 | 11.36622% |
| Blackberries, Organic, IQF | North Pacific ™ | 100.000 | 11.36622% |
| Water | Pacific Choice ™ | 150.000 | 17.04933% |
| Cane Sugar, Organic | Florida Crystals ™ | 250.000 | 28.41555% |
| Citric Acid 50% | | 16.000 | 1.81860% |
| Pectin | Danisco ™ | 8.300 | 0.94340% |
| Mixed Berry Flavor | Ungerer ™ | 2.500 | 0.28416% |
| Locust Bean Gum | TIC ™ | 1.800 | 0.20459% |
| Fruit Juice (Color) | Exberry ™ | 1.000 | 0.11366% |
| Antifoam, Organic | Magrabar ™ | 0.200 | 0.02273% |
| Compliant | | | |
| | | 879.80 | 100.00001% |

Production proceeds as follows. A pre-blend is formed of the pectin and the locust bean gum mixed with 20% of the cane sugar. The pre-blend is combined with the water and brought to a boil and held at boil for approximately one minute. Temperature is adjusted to 160° F. and the fruit is added. Temperature is raised to 180° F. with addition of the antifoam. Temperature is raised to 195° F. and the remaining 80% of sugar is added. Flavor, color, and citric acid are added. The mixture is hot-filled into containers, sealed, and cooled.

We claim:

1. A spreadable fruit preparation comprising:
fruit;
sugar;
citric acid; and
pectin;
wherein the percent by weight of total soluble solids of the spreadable fruit preparation is less than 50 percent, the sugar content of one mL of the spreadable fruit preparation is less than about 0.634 grams of sugar per mL of the spreadable fruit preparation, and the caloric content of the spreadable fruit preparation is less than about 2.536 kilocalories per mL.

2. The spreadable fruit preparation of claim 1, wherein the percent by weight of total soluble solids is less than 40 percent.

3. The spreadable fruit preparation of claim 1, wherein the sugar content of one mL of the spreadable fruit preparation is less than about 0.4 grams of sugar per mL of the spreadable fruit preparation.

4. The spreadable fruit preparation of claim 1, wherein the caloric content is less than about 1.6 kilocalories per mL of the spreadable fruit preparation.

5. The spreadable fruit preparation of claim 1, wherein the spreadable fruit preparation does not contain a sugar substitute.

6. The spreadable fruit preparation of claim 1, wherein the fruit is selected from the group consisting of strawberry, raspberry, blackberry, peach, apricot, blueberry, boysenberry, cherry, pineapple, pomegranate, and orange.

7. The spreadable fruit preparation of claim 1, wherein the sugar is selected from the group consisting of sucrose, glucose, and fructose.

8. The spreadable fruit preparation of claim 1, wherein the spreadable fruit preparation is provided in a hermetically sealed container.

9. The spreadable fruit preparation of claim 8, wherein the spreadable fruit preparation is stable at room temperature for one year.

10. A method of manufacturing a spreadable fruit preparation, the method comprising:
combining fruit, sugar, citric acid, and pectin to form a mixture; and
heating the mixture to yield the spreadable fruit preparation;
wherein the percent by weight of total soluble solids of the spreadable fruit preparation is less than 50 percent, the sugar content of one mL of the spreadable fruit preparation is less than about 0.634 grams of sugar per mL of the spreadable fruit preparation, and the caloric content of the spreadable fruit preparation is less than about 2.536 kilocalories per mL.

11. The method of claim 10, wherein the percent by weight of total soluble solids of the spreadable fruit preparation is less than 40 percent.

12. The method of claim 10, wherein the sugar content of one mL of the spreadable fruit preparation is less than about 0.4 grams of sugar per mL of the spreadable fruit preparation.

13. The method of claim 10, wherein the caloric content of one mL of the spreadable fruit preparation is less than about 1.6 kilocalories per mL of the spreadable fruit preparation.

14. The method of claim 10, wherein the spreadable fruit preparation does not contain a sugar substitute.

15. The method of claim 10, wherein the fruit is selected from the group consisting of strawberry, raspberry, blackberry, peach, apricot, blueberry, boysenberry, cherry, pineapple, pomegranate, and orange.

16. The method of claim 10, wherein the sugar is chosen from the group consisting of sucrose, glucose, and fructose.

17. The method of claim 10, further comprising the step of:
providing the spreadable fruit preparation in a hermetically sealed container.

18. The method of claim 17, wherein the spreadable fruit preparation is stable at room temperature for one year.
